(19) United States
(12) Patent Application Publication
(10) Pub. No.: US 2025/0265733 A1
(43) Pub. Date: Aug. 21, 2025

(54) LOW-FOOTPRINT MODEL APPLICABLE TO OPTICAL FLOW ESTIMATION AND STEREO MATCHING

(71) Applicant: QUALCOMM Incorporated, San Diego, CA (US)

(72) Inventors: Jamie Menjay LIN, San Diego, CA (US); Jisoo JEONG, San Diego, CA (US); Hong CAI, San Diego, CA (US); Fatih Murat PORIKLI, San Diego, CA (US); Kai WANG, San Diego, CA (US)

(21) Appl. No.: 18/583,185

(22) Filed: Feb. 21, 2024

(51) Int. Cl. G06T 7/00

(52) U.S. Cl. CPC G06T 7/97; G06T 2207/20084

(57) ABSTRACT

A device includes a memory configured to store input data, and also includes one or more processors configured to process the input data using a machine learning model that incorporates a softmax with norm folding mechanism.

### I. FIELD

The present disclosure is generally related to low-footprint models that are applicable to optical flow estimation and stereo matching.

### II. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Such computing devices often incorporate functionality to perform multi-image processing techniques that involve comparisons between pairs of images, such as to track motion of objects between sequential video frames using optical flow (OF) techniques or to estimate depth information based on the visual disparity between corresponding points of a pair of stereo images, referred to herein as depth from stereo (DFS). However, conventional methods for OF and DFS estimation typically have a large memory requirement or “footprint” that can render such techniques impractical for use in a resource-constrained environment.

As an example, methods for OF and DFS estimation conventionally rely on the use of cost volumes, which are large data structures that are used to store values associated with cost calculations for individual paths, displacements, or disparities. As a simplified example, DFS estimation uses stereo matching for a left image and a right image and includes performing feature extraction to generate a feature map for the left image having dimensions of height (H) and width (W_{L}) and a feature map for the right image having dimensions of H and W_{R}. A cost volume is generated that stores the three-dimensional (H, W_{R}, W_{L}) interaction data, such as correlation values, which are then processed to determine a disparity—the size of a pixel offset between the left and right image-associated with each row of the images. For OF estimation, the cost volume to store the interaction data between the feature map of a first image “t” having dimensions Hₜ, Wₜ and the feature map of a next image “t+1” having dimensions Hₜ₊₁, Wₜ₊₁ is even larger and requires storage of four-dimensional (Hₜ, Wₜ, Hₜ₊₁, Wₜ₊₁) interaction data. Both DFS and OF also require additional memory for intermediate calculations.

In a particular example, evaluation of a softmax operation in a conventional model includes performing multiple passes over the input data. For example, because the softmax operation includes generating a series of normalized values based on an input tensor, such as a matrix of input data, a first pass is used to generate a series of values based on the input data, and a second pass is used to normalize the values based on a sum of the intermediate values. This multi-pass evaluation requires buffering of the input tensor to sequentially traverse tensor entries and also creates a “break point” in the computation pipeline that prevents further processing until the multi-pass evaluation is completed. The impact of multi-pass softmax evaluation is heightened when the softmax is used in an attention mechanism, such as in a transformer, as the input tensor involves quadratic complexity. To illustrate, when evaluating two sets of input data associated with two images and each having a size of order N (e.g., O(N)), the complexity associated with processing the input tensor is of O(N²)

Some devices, such as graphics processing units (GPUs) that are specialized for high-volume computations, can include a large enough on-chip memory for the cost volumes and intermediate computations that are needed for DFS and OF. However, such devices are expensive and consume large amounts of power, and are therefore not practical for use in a resource-constrained environment, such as a mobile phone or an extended reality (XR) headset.

### III. SUMMARY

According to a particular implementation of the techniques disclosed herein, a device includes a memory configured to store input data. The device also includes one or more processors configured to process the input data using a machine learning (ML) model that incorporates a softmax with norm folding mechanism.

According to a particular implementation of the techniques disclosed herein, a method includes obtaining input data at a device. The method also includes processing, at the device, the input data using a machine learning (ML) model including performing a softmax with norm folding operation.

According to a particular implementation of the techniques disclosed herein, a non-transitory computer-readable medium stores instructions that, when executed by one or more processors, cause the one or more processors to obtain input data and to process the input data using a machine learning (ML) model that incorporates a softmax with norm folding mechanism.

Other implementations, advantages, and features of the present disclosure will become apparent after review of the entire application, including the following sections: Brief Description of the Drawings, Detailed Description, and the Claims.

### IV. Brief Description of the Drawings

FIG. 1 is a block diagram illustrating an example of an implementation of a system operable to perform input data processing using a low-footprint model, in accordance with some examples of the present disclosure.

FIG. 2 is a block diagram illustrating an example of components and operations that can be implemented in the system of FIG. 1, in accordance with some examples of the present disclosure.

FIG. 3 is a block diagram illustrating an example of components and operations that can be implemented in the system of FIG. 1, in accordance with some examples of the present disclosure.

FIG. 4 is a block diagram illustrating an example of a low-footprint model having a depth from stereo or optical flow architecture that can be implemented in the system of FIG. 1, in accordance with some examples of the present disclosure.

FIG. 5 is a block diagram illustrating an implementation of an integrated circuit operable to perform input data processing using a low-footprint model, in accordance with some examples of the present disclosure.

FIG. 6 is a diagram of an implementation of a portable electronic device operable to perform input data processing using a low-footprint model, in accordance with some examples of the present disclosure.

FIG. 7 is a diagram of a camera operable to perform input data processing using a low-footprint model, in accordance with some examples of the present disclosure.

FIG. 8 is a diagram of a wearable electronic device operable to perform input data processing using a low-footprint model, in accordance with some examples of the present disclosure.

FIG. 9 is a diagram of an extended reality device, such as augmented reality glasses, operable to perform input data processing using a low-footprint model, in accordance with some examples of the present disclosure.

FIG. 10 is a diagram of a headset, such as a virtual reality, mixed reality, or augmented reality headset, operable to perform input data processing using a low-footprint model, in accordance with some examples of the present disclosure.

FIG. 11 is a diagram of a voice-controlled speaker system operable to perform input data processing using a low-footprint model, in accordance with some examples of the present disclosure.

FIG. 12 is a diagram of a first example of a vehicle operable to perform input data processing using a low-footprint model, in accordance with some examples of the present disclosure.

FIG. 13 is a diagram of a second example of a vehicle operable to perform input data processing using a low-footprint model, in accordance with some examples of the present disclosure.

FIG. 14 is a diagram of a particular implementation of a method of performing input data processing using a low-footprint model, in accordance with some examples of the present disclosure.

FIG. 15 is a block diagram of a particular illustrative example of a device that is operable to perform input data processing using a low-footprint model, in accordance with some examples of the present disclosure.

### V. DETAILED DESCRIPTION

Systems and methods to perform input data processing using a low-footprint model are disclosed. Conventional methods for performing techniques such as OF and DFS estimation typically have a large memory footprint that can render such techniques impractical for use in a resource-constrained environment. For example, methods for OF and DFS estimation conventionally rely on the use of cost volumes, which are large data structures that are used to store values associated with cost calculations for individual paths, displacements, or disparities. Some such conventional methods can include evaluation of a softmax operation that includes performing multiple passes over the input data, which can require a large amount of buffering and creates a break point in the computation pipeline that prevents further processing until the multi-pass evaluation is completed.

The disclosed techniques enable performance of input data processing, such as for performing OF and DFS estimation, with significantly reduced memory usage as compared to conventional approaches. The use of relatively low-footprint models according to the present techniques enables processing for applications such as OF and DFS estimation to be efficiently performed in resource-constrained environments.

In accordance with the present techniques, instead of performing conventional OF or DFS processing using cost volumes, a machine-learning model that includes an attention mechanism is used to generate probabilistic geometry measures without generating a cost volume data structure. To illustrate, according to a first aspect, the probabilistic measures are used to regress on geometric coordinates without the use of a cost volume. Elimination of the cost volume reduces memory usage associated with OF or DFS processing.

According to a second aspect, the disclosed techniques improve the operation of the softmax compute path in the attention mechanism. For example, a norm folding mechanism is incorporated in the softmax compute path that applies a normalization factor at a later point in the compute path as compared to conventional multi-pass techniques. As a result, the data flow in the attention computation remains “streamable”—that is, no buffering or execution breakpoint is needed even for large input data sizes—and enables depth-first computation without requiring softmax memory buffering.

According to a third aspect, the disclosed techniques include using just-in-time regression for OF or DFS geometric coordinates. For example, each matrix in the attention mechanism has a linear space complexity with respect to the token size, e.g., O(N). As compared to conventional attention mechanisms in which quadratic memory buffering (e.g., O(N²)) is required, the matrix multiplication is instead performed with suitable partitioning of the matrices in the rows of one matrix and the columns of the other matrix, such that quadratic buffering is no longer needed in the memory. Depth-first computation may also be applied to reduce the amount of buffering in the computation pipeline.

Combining the above aspects into a single, low-footprint model for processing input data, such as for OF or DFS estimation, can greatly enhance operation of a device implementing the model. Further, operation can also be enhanced in devices that implement fewer than all of the above aspects. In particular, each of the above aspects independently improves performance of OF or DFS estimation by reducing memory usage, which reduces read/write accesses that may otherwise result from overflow memory accesses when the memory usage exceeds available on-chip memory capacity. Reduction in overflow memory accesses can directly result in reduced latency and power consumption and therefore improves the performance of a device implementing one or more of the disclosed techniques.

Although the following description is primarily directed to examples of the present techniques in the context of using OF and DFS estimation, the present techniques are not limited to OF and DFS applications. For example, the present techniques can also be used to reduce memory usage and improve performance in applications such as large language models, transformer models such as for computer vision, diffusion models such as for text-to-image generative models, etc., that may incorporate attention and/or softmax mechanisms. To illustrate, in some embodiments the present techniques are used to improve performance in large language models (LLMs), large vision models (LVMs), large multimodal models (LMMs), or a combination thereof.

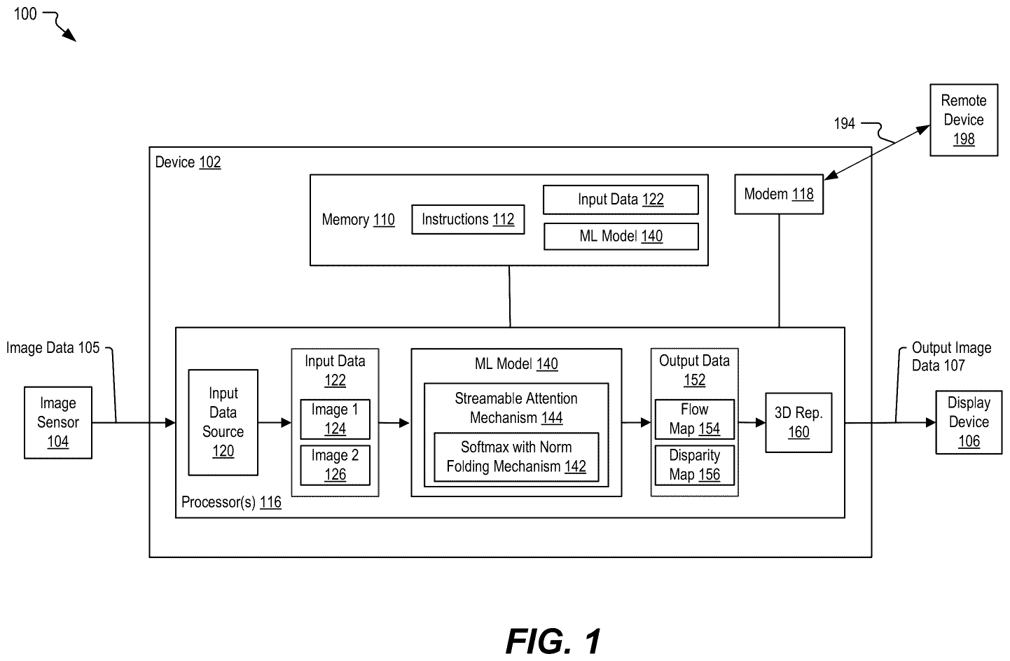

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 116 of FIG. 1), which indicates that in some implementations the device 102 includes a single processor 116 and in other implementations the device 102 includes multiple processors 116. For ease of reference herein, such features are generally introduced as “one or more” features and are subsequently referred to in the singular or optional plural (as indicated by “(s)” in the name of the feature) unless aspects related to multiple of the features are being described.

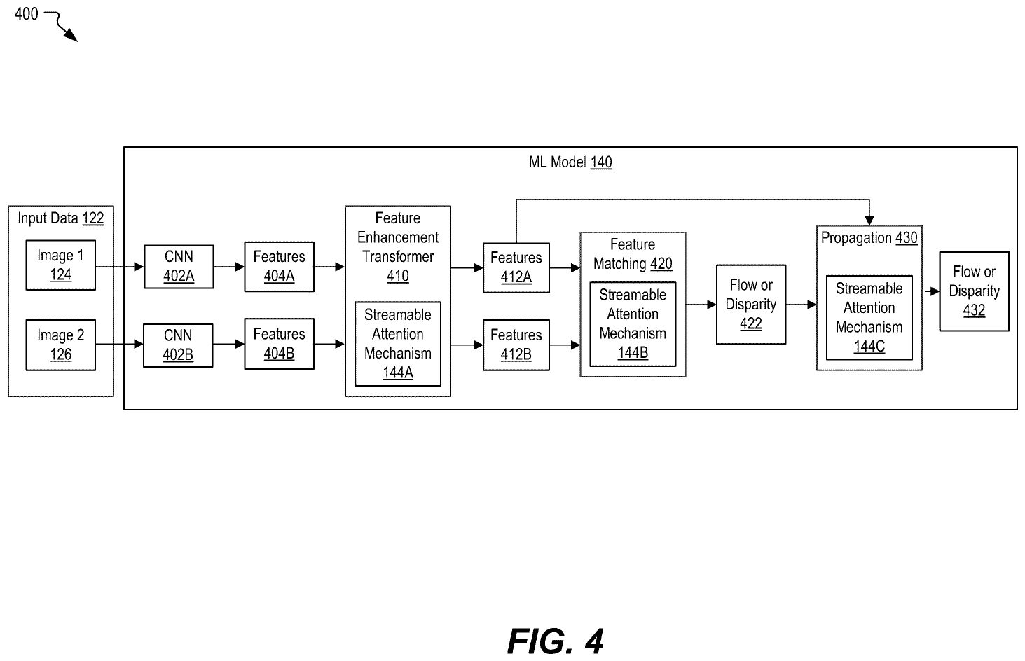

In some drawings, multiple instances of a particular type of feature are used. Although these features are physically and/or logically distinct, the same reference number is used for each, and the different instances are distinguished by addition of a letter to the reference number. When the features as a group or a type are referred to herein, e.g., when no particular one of the features is being referenced, the reference number is used without a distinguishing letter. However, when one particular feature of multiple features of the same type is referred to herein, the reference number is used with the distinguishing letter. For example, referring to FIG. 4, multiple convolutional neural networks (CNNs) are illustrated and associated with reference numbers 402A and 402B. When referring to a particular one of these CNNs, such as a CNN 402A, the distinguishing letter “A” is used. However, when referring to any arbitrary one of these CNNs or to these CNNs as a group, the reference number 402 is used without a distinguishing letter.

As used herein, the terms “comprise,” “comprises,” and “comprising” may be used interchangeably with “include,” “includes,” or “including.” Additionally, it will be understood that the term “wherein” may be used interchangeably with “where.” As used herein, “exemplary” may indicate an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “obtaining,” “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, retrieving, receiving, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

Referring to FIG. 1, a particular illustrative aspect of a system 100 is depicted that includes a device 102 that is configured to perform input data processing using a low-footprint model. For example, the device 102 is configured to process input data 122 using a machine learning (ML) model 140 that includes a softmax with norm folding mechanism 142. Use of the softmax with norm folding mechanism 142 reduces the buffering requirements of conventional softmax mechanisms and can further reduce the footprint of the ML model 140 by enabling depth-first computation, as described further below.

Optionally, the device 102 includes, or is coupled to, one or more image sensors 104. The image sensor 104 is configured to generate image data 105 that, in some embodiments, corresponds to the input data 122. In a particular embodiment, the image sensor 104 corresponds to or is incorporated into a camera, such as a still image camera, a video camera, a stereo camera, a thermal imaging camera, one or more other types of camera, or a combination thereof. According to an aspect, the image data 105 includes data (e.g., pixel values) of individual images, video data, or a combination thereof.

The device 102 includes a memory 110 coupled to the one or more processors 116 and configured to store instructions 112 and input data 122, such as individual images or data corresponding to images included in video data (e.g., video frames). For example, the memory 110 may include a first image 124 and a second image 126 as part of the input data 122 to be processed at the ML model 140, as described in further detail below. The memory 110 may also store data (e.g., parameters, such as weights and biases) associated with one or more ML models, such as the ML model 140, that may be implemented at the one or more processors 116. In a particular implementation, the memory 110 corresponds to a dynamic random access memory (DRAM) of a double data rate (DDR) memory subsystem.

The one or more processors 116 are configured to execute the instructions 112 to perform operations associated with the ML model 140. In various implementations, some or all of the functionality associated with ML model 140 is performed via execution of the instructions 112 by the one or more processors 116, performed by processing circuitry of the one or more processors 116 in a hardware implementation, or a combination thereof.

The one or more processors 116 may include an input data source 120 coupled to the ML model 140 and configured to provide the input data 122 to the ML model 140. For example, the input data source 120 may correspond to the image sensor 104, a portion of one or more of media files (e.g., a media file including the input images 124, 126 that is retrieved from the memory 110), one or more other sources of image information, such as from a remote media server, or a combination thereof.

The one or more processors 116 are configured to process the input data 122 using the ML model 140 that incorporates the softmax with norm folding mechanism 142 to generate output data 152. To illustrate, in a particular embodiment, the input data 122 includes the first image 124 and the second image 126, and the ML model 140 corresponds to an OF or DFS architecture that generates a flow map 154 or a disparity map 156, respectively, such as described further with reference to FIG. 4. According to an aspect, instead of performing conventional OF or DFS using cost volumes, the ML model 140 is used to generate probabilistic geometry measures without generating a cost volume data structure.

As illustrated, the softmax with norm folding mechanism 142 is included in a streamable attention mechanism 144 of the ML model 140. In general, an attention function can be calculated as:

$$Attention ( Q , K , V ) = softmax ( \frac{{QK}^{T}}{\sqrt{{d}_{k}}} ) V = PV ,$$

where Q can correspond to a matrix of features of one image (e.g., a feature map), K can correspond to a matrix of features of the other image, \sqrt{dₖ} is a constant normalization factor, and V can correspond to a matrix of displacement values (e.g., values of Δx for DFS, or Δx, Δy for OF). In this example, P represents a matrix of probability values (in the range [0,1]) which, when multiplied by the displacement values in V, result in expectation values. Q, K, and V can each have linear complexity (e.g., O(N)), and a naive approach to computing QK^{T} has quadratic complexity (e.g., O(N²)), which is similar to a conventional cost volume approach.

Conventionally, the softmax function,

$${softmax ( z )}_{i} = {σ ( z )}_{i} = \frac{{e}^{{z}_{i}}}{{\sum }_{j = 1}^{K} {e}^{{z}_{j}}} for i = 1 , … , K and$$

$$z = ( {z}_{1} , … , {z}_{K} ) ∈ {ℝ}^{K} ,$$

is computed using a multi-pass technique in which the numerator values e^{z}^{ᵢ} are computed, the denominator is computed as the accumulated sum over the numerator values, and the values of σ(z)ᵢ are computed by dividing each numerator value by the denominator. Such a multi-pass approach requires buffering of the values that are generated in each pass. As a result, a stream of input values sent to the softmax computation block is interrupted due to the buffering, creating a computation pipeline break point that prevents further processing until the multi-pass evaluation is completed. In some examples, latency that is incurred while buffering the incoming values for the softmax computation can be prohibitive. In some instances, the amount of data to be buffered can exceed the capacity of an on-chip memory of the processor 116, and data transfers of the buffered data to and from a higher capacity storage (e.g., the memory 110) of the device 102 are performed, resulting in additional increases in latency and power consumption.

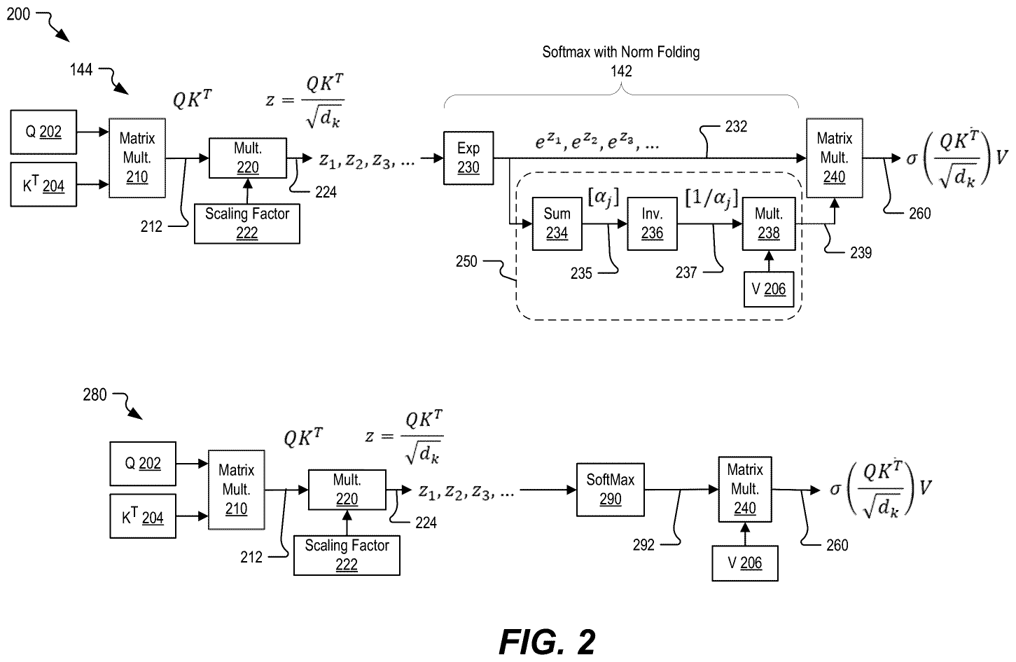

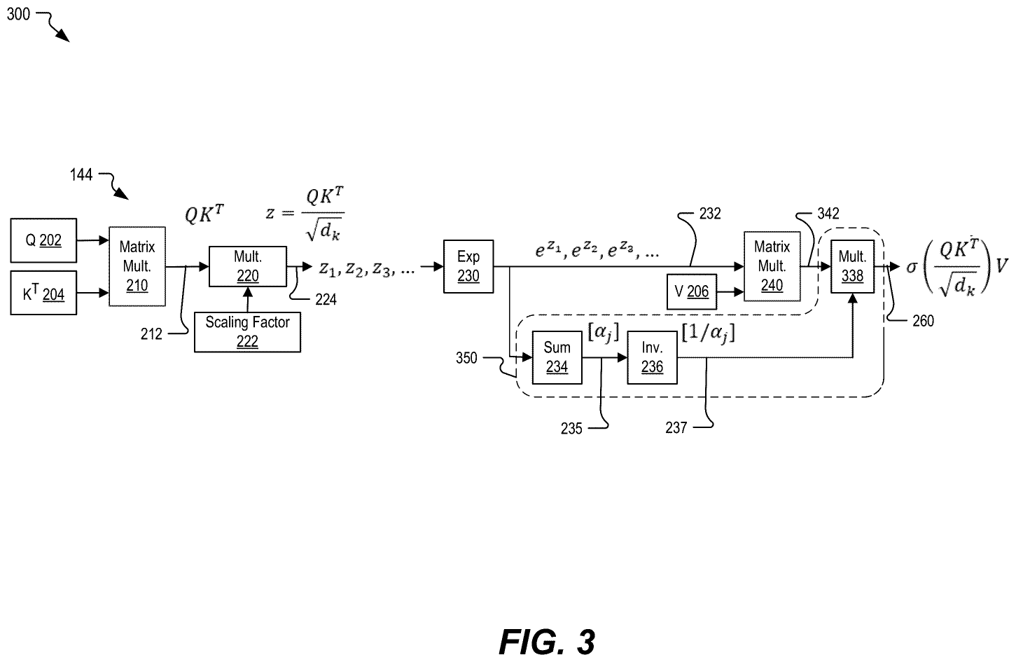

The disclosed techniques improve the operation of the softmax compute path, including incorporating a norm folding mechanism, so that the data flow in the streamable attention mechanism 144 remains “streamable”—that is, no buffering or execution breakpoint is needed even for large sizes of Q and K—and enables depth-first computation. Examples of computational components (e.g., network layers) of the streamable attention mechanism 144, including the softmax with norm folding mechanism 142, are depicted in FIG. 2 and FIG. 3 and compared to an example of a conventional attention mechanism that is depicted in FIG. 2.

According to an aspect, the ML model 140 is configured to perform regression for OF or DFS geometric coordinates using just-in-time computations. Just-in-time computations can enable the one or more processors 116 to compute and consume computation as late as possible to avoid having to store computation results for later use. In general, there is a basic unit of operands that is needed at any given time during processing of the input data 122 at the ML model 140, and once computations have completed for that scope of operands, all intermediate computations are no longer needed and can be discarded, and a next batch of operands is loaded into memory. For example, during the softmax computation to determine Pᵢⱼ based on the row Qᵢ and the column Kⱼ, the device 102 loads Qᵢ and Kⱼ into memory (either in their entirety or as a series of partitioned portions, as described below) and evaluates the inner product of Qᵢ and Kⱼ to determine Pᵢⱼ. Reading any rows besides Qᵢ or any columns besides Kⱼ into memory would be premature and unnecessarily increase memory usage beyond that required for the computation.

To illustrate, in a naive computation approach, all entries of Qᵢ and Kⱼ are loaded into memory and all of the intermediate computations for Qᵢ and Kⱼ are stored. If Qᵢ and Kⱼ each have size “S,” the amount of memory needed to store Qᵢ and Kⱼ is 2S, and the amount of memory needed to store all of the intermediate computations is S². However, by partitioning Qᵢ and Kⱼ into basic units of operands that are loaded into memory on an as-needed basis and performing just-in-time computations, the amount of memory used to process the input data 122 at the ML model 140 can be significantly reduced. For example, a basic unit of operands can be 64 entries from each of Qi and Kj, and computation of the accumulation of numerator terms for the softmax operation can be performed for a first set of 64 entries of Qᵢ and Kⱼ, followed by a next set of 64 entries of Qᵢ and Kⱼ, and so on, until all entries of Qᵢ and Kⱼ, have been processed, and an accumulated total of all the numerator terms has been generated.

According to an aspect, the one or more processors 116 are configured to perform depth-first computations in which intermediate computations are calculated and consumed for one unit of operands before processing a next unit of operands, thus circumventing the need to store the intermediate computations for later use and providing enhanced efficiency.

The output data 152 can include information generated as a result of processing the input data 122 at the ML model 140. For example, in embodiments in which the ML model 140 has an OF architecture, the output data 152 can include a flow map 154. In general, an optical flow can indicate a pattern of apparent motion of objects, surfaces, and edges in a visual scene caused by the relative motion between an observer (e.g., the image sensor 104, a robotic device, etc.) and a scene. The flow map 154 can include optical flow information that may be used to measure the motion of the device 102 relative to an object or scene. The optical flow information may also be used to measure visual motion or relative motion between the device 102 and one or more other objects in the vicinity of the device 102. In addition, or alternatively, the device 102 may use the optical flow information for motion detection, object segmentation, stereo disparity measurements, etc.

In embodiments in which the ML model 140 has a DFS architecture, the output data 152 can include a disparity map 156. The disparity map 156 can be used to generate depth information, such a depth map, that may be employed in a number of different embodiments, such as for navigation in an environment to avoid obstacles or to plan routes. To illustrate, the device 102 can be implemented in, or may correspond to, a fully autonomous, semi-autonomous, or fully user-controlled drone or other motorized vehicle. In some embodiments, the device 102 (e.g., the image sensor 104) may capture images of one or more objects or a scene and generate depth maps from those images. Such depth maps may be used to determine distances between objects in the scene, heights of objects, etc.

In some embodiments, the one or more processors 116 may generate or update a 3D representation 160 of an object or scene based on the image data 105 and the output data 152. For example, the one or more processors 116 may process the output data 152 to determine 3D characteristics of an object in the input data 122, such as height, depth, etc., to generate the 3D representation 160. The one or more processors 116 may update or refine the 3D representation 160 based on updated information in the input data 122 and/or the output data 152, such as in response to the image sensor 104 capturing additional images of the object that differ from previous images due to relative motion between the device 102 and the object. The one or more processors 116 may be configured to generate one or more 2D images representing the 3D representation 160 of the object or scene, such as from a novel viewpoint of the 3D representation, to display to a user of the device 102, as an illustrative, non-limiting example.

Although in some embodiments the ML model 140 may be trained at the device 102, in other embodiments the ML model 140 is not trained at the device 102. To illustrate, the ML model 140 may be trained at a remote device, such as a remote device 198, and the trained ML model 140 may be transmitted to the device 102 and stored in the memory 110.

The device 102 optionally includes or is coupled to a display device 106. The display device 106 is configured to display output image data 107 corresponding to the output data 152 for viewing by a user of the device 102. For example, in some embodiments in which the one or more processors 116 generate the 3D representation 160 of an object or scene based on the image data 105, the one or more processors 116 may generate the output image data 107 based on the 3D representation 160, such as in an extended reality application.

The device 102 optionally includes a modem 118 that is coupled to the one or more processors 116 and configured to enable communication with one or more other devices, such as via one or more wireless networks. According to some aspects, the modem 118 is configured to receive the image data 105, the input data 122, or both, from a second device, such as image data (e.g., included in video data) that is streamed via a wireless transmission 194 from a remote device, such as the remote device 198 (e.g., a remote server) for processing at the device 102. According to some aspects, the modem 118 is configured to send data corresponding to the output data 152, the 3D representation 160, or both, to a second device, such as image data (e.g., associated with the 3D representation 160) that is streamed via the wireless transmission 194 to a remote device 198 (e.g., a remote server or user device) for storage or playback.

A technical advantage of using the ML model 140 is that, as compared to conventional techniques, the ML model 140 is a low-footprint model that can be run using reduced memory usage, which reduces read/write accesses that may otherwise result from overflow memory accesses when the memory usage exceeds available on-chip memory capacity. Reduction in overflow memory accesses can directly result in reduced latency and power consumption, which improves the overall performance of the device 102.

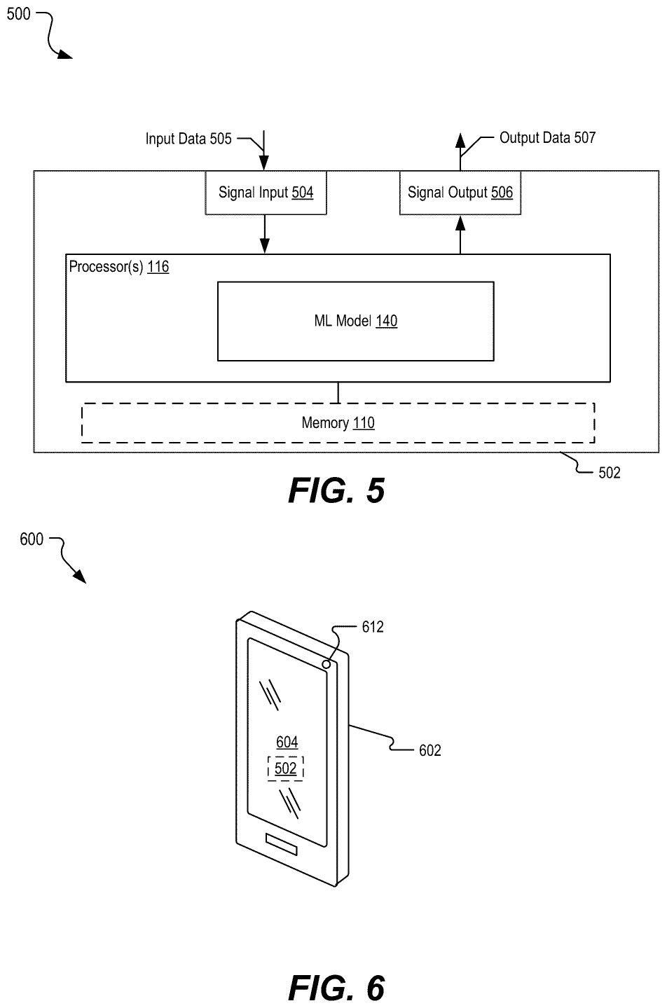

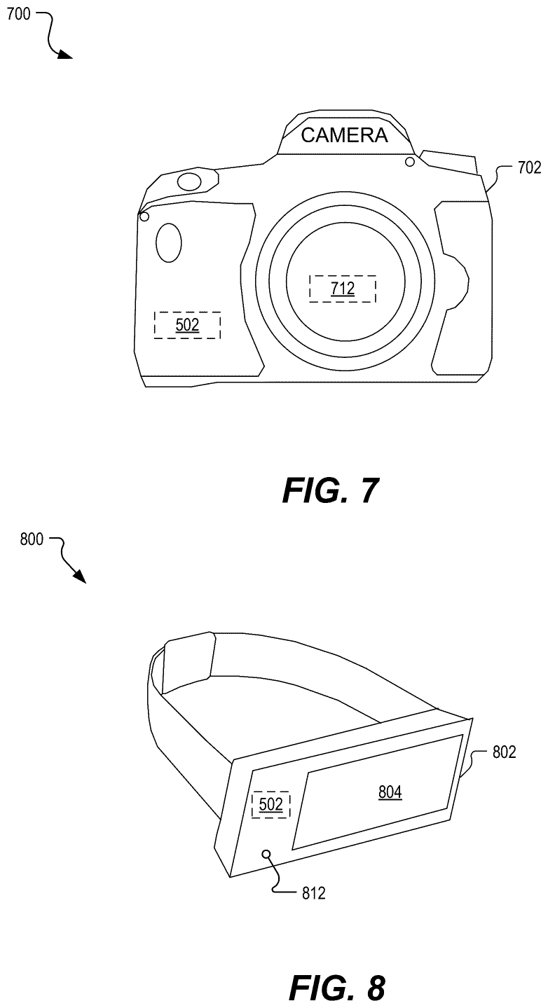

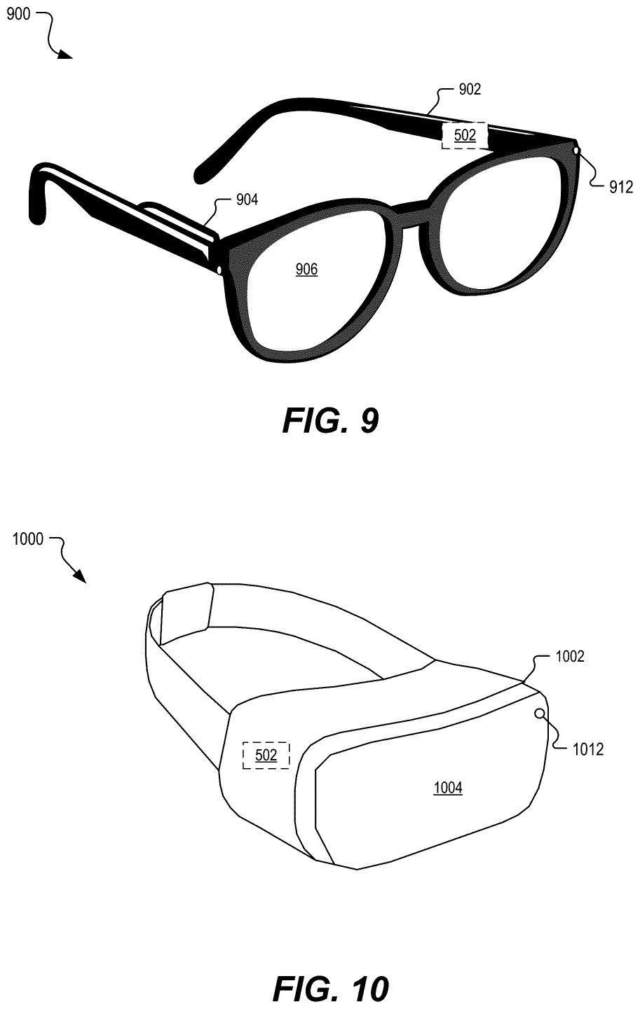

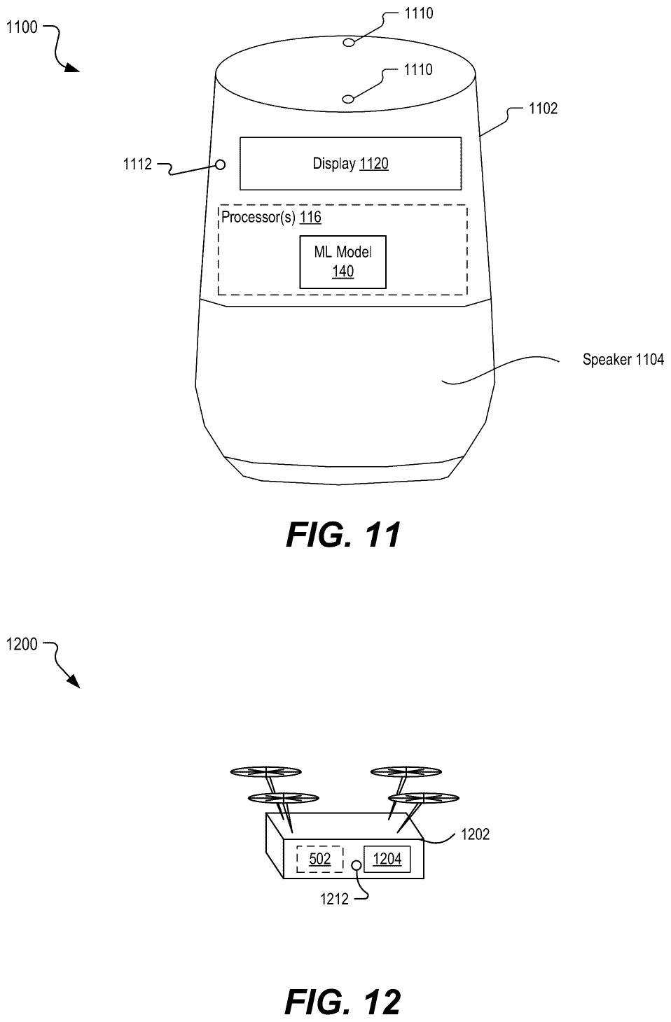

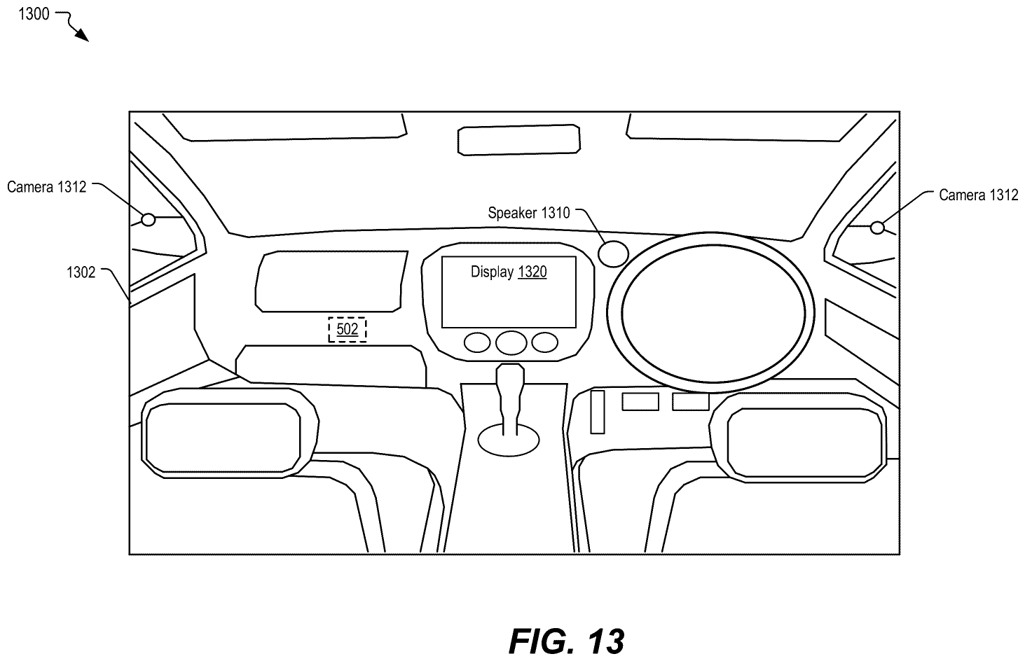

According to some aspects, the one or more processors 116 are integrated in an integrated circuit, such as illustrated in FIG. 5. According to some aspects, the one or more processors 116 are integrated in at least one of a mobile phone or a tablet computer device, such as illustrated in FIG. 6, a camera device, such as illustrated in FIG. 7, or a wearable electronic device, such as illustrated in FIG. 8. According to some aspects, the one or more processors 116 are integrated in a headset device that includes a display and that is configured, when worn by a user, to display an output image based on an output of the ML model 140, such as illustrated in FIG. 9 and FIG. 10. According to some aspects, the one or more processors 116 are integrated in a voice-controlled speaker system, such as illustrated in FIG. 11. According to some aspects, the one or more processors 116 are integrated in a vehicle that also includes one or more cameras configured to capture image data corresponding to the input data 122, such as illustrated in FIG. 12 and FIG. 13.

It should be understood that one or more aspects of the device 102 may have been omitted from the above description for clarity of explanation. For example, although in some embodiments the input data 122 matches the image data 105, in other embodiments the input data 122 may be the result of additional processing that is performed on the image data 105. Such additional processing can include cropping, zooming, tone mapping, color enhancement, upscaling, or downscaling, as illustrative, non-limiting examples.

Although OF and DFS are described as example architectures of the ML model 140, it should be noted that the present techniques are not limited to OF and DFS applications. In a particular example, the cost-volume-less OF and DFS processing eliminates the quadratic memory requirement associated with on-device attentions and transformers for determining OF, DFS, and stereo matching/depth estimation, such as depth estimation for spatial matching and OF estimation for temporal matching, which enables improved performance in applications such as mobile cameras, autonomous vehicles, extended reality headset devices (e.g., glasses), etc. In another example, the streamable softmax and attention processing (e.g., of the streamable attention mechanism 144 and the softmax with norm folding mechanism 142) can help remove execution pipelining and memory bottlenecks associated with operating transformer models on mobile devices, such as computer vision and language models in which the softmax function can be responsible for more than half of the total latency of the model. In another example, the elimination of the quadratic memory requirement by use of the streamable softmax processing improves the operation of the device 102 in embodiments in which the ML model 140 is a diffusion model, such as a text-to-image generative model on a mobile device. In another example, the streaming pipelining and the elimination of the quadratic memory requirement associated with on-device attentions and transformers, enabled by the streamable attention of the present disclosure, improves the performance associated with running large language models (LLMs), such as LLMs with very large token sizes, and LLMs on mobile devices with relatively constrained on-device memory. According to some embodiments, the present techniques are used to improve performance in language models such as LLMs, vision models such as LVMs, and/or multi-modal models such as LMMs (which may be viewed as an extension of LLMs or LVMs that operate on multi-modal input data). For example, the present techniques can be implemented in an LMM that processes input data corresponding to multiple modalities of input/sensor sources, such as audio, speech, text, images, videos etc., and that incorporates neural network processing, including a streamable attention mechanism, that provides improved performance to handle a large size of attention tokens, in a similar manner as for LLMs or LVMs.

FIG. 2 depicts an example 200 of components and operations that may be implemented in the device 102 of FIG. 1, according to some examples of the present disclosure. In particular, the example 200 illustrates components and operations that may be implemented in the streamable attention mechanism 144.

The streamable attention mechanism 144 is configured to receive first data (Q) 202 and second data (K) 204. Each of the first data (Q) 202 and the second data (K) 204 may correspond to a matrix of features values (e.g., a feature map) of a corresponding input image. According to an aspect, the second data 204 represents a transpose of a matrix of feature values (e.g., K^{T}). In a particular embodiment, the first data 202 corresponds to features associated with the first image 124, and the second data 204 corresponds to features associated with the second image 126. The streamable attention mechanism 144 also receives third data (V) 206 that corresponds to a displacement matrix of coordinates, as described further below.

The streamable attention mechanism 144 is configured to generate a softmax input stream 224 based on a first matrix multiplication operation 210 of a particular row of the first data 202 and a corresponding row of the second data 204. To illustrate, a stream of values 212 (e.g., QK^{T}) that are output from the first matrix multiplication operation 210 are scaled by a scaling factor 222 (e.g., \sqrt{dₖ}) at a multiplication operation 220 to generate the softmax input stream 224 (e.g., z₁, z₂, z₃, . . . , corresponding to elements of the tensor z=QK^{T}/\sqrt{dₖ}).

An exponentiation operation 230 of the softmax with norm folding mechanism 142 is applied to the softmax input stream 224 to generate a stream of softmax numerator values 232 (e.g., e^{z}^{₁}, e^{z}^{₂}, e^{z}^{₃}, . . . ). The exponentiation of each element of the softmax input stream 224 is performed in the 1-pass traversal of z, as each entry zᵢ is individually available in the softmax input stream 224. The exponentiation of each element of the softmax input stream 224 is not dependent on any other element in the softmax input stream 224. Thus, the exponentiation operation 230 is streamable, as no buffering is required.

The stream of softmax numerator values 232 is input, in a first processing path, as a first input to a second matrix multiplication operation 240. In a second processing path parallel to the first processing path, an accumulation sum 235 of the softmax numerator values 232 is generated at a sum operation 234 along the same 1-pass traversal of Z. The accumulation sum 235 can include parallel evaluation of M attention functions (M is a positive integer) and correspond to a norm vector [αⱼ], with j=1, 2, . . . , M, and α≙Σᵢe^{z}^{ᵢ}, for a suitable range of i=1, 2, . . . , K associated with the attention function.

The streamable attention mechanism 144 is configured to perform a norm operation 250 to apply the accumulation sum 235 to the third data (V) 206 to generate a second input 239 to the second matrix multiplication operation 240. For example, after all of the softmax numerator values 232 have been accumulated into the accumulation sum 235, the norm operation 250 includes applying an inverse operation 236 to generate the inverse of the accumulation sum 235, represented as an inverse accumulation sum 237 (e.g., a norm vector N=[1/αⱼ]). The inverse accumulation sum 237 is multiplied with the elements of the third data (V) 206 at a multiplication operation 238 to generate the second input 239 to the second matrix multiplication operation 240.

The second matrix multiplication operation 240 multiplies the softmax numerator values 232 with the second input 239 (e.g., the product of the inverse accumulation sum 237 with the third data (V) 206) to generate the attention output values 260, e.g., σ(QK^{T}/\sqrt{dₖ})).

Applying the inverse accumulation sum 237 at a later stage in the computation flow (e.g., not immediately applying the inverse accumulation sum 237 to the softmax numerator values 232 to generate normalized softmax values) is referred to as “norm folding” and can be used with or without depth-first computation, according to design choice. The use of norm folding enables the processing of the stream of softmax numerator values 232 to continue without interruption due to buffering. The norm folding may be implemented as dynamic norm folding in embodiments in which the point in the computation flow where the inverse accumulation sum 237 is applied is selected based on one or more factors, such as a size of the input images. For example, the inverse accumulation sum 237 may be applied earlier in the computation flow (e.g., applied to V 206 prior to input to the second matrix multiplication operation 240) for smaller images (e.g., Video Graphics Array (VGA)) and may be applied later in the computation flow (e.g., applied after the second matrix multiplication operation 240, such as depicted in FIG. 3) for larger images (e.g., 4K).

For purposes of comparison, an example 280 depicts a conventional attention mechanism. The softmax input stream 224 is generated in a substantially similar manner as described for the example 200 and provided to a conventional softmax computation block 290. An output 292 of the conventional softmax computation block 290 and the third data (V) 206 are multiplied at the second matrix multiplication operation 240 to generate the attention output values 260. Because a conventional softmax computation includes one pass that accumulates all of the numerator values (e.g., e^{z}^{₁}, e^{z}^{₂}, e^{z}^{₃}, . . . ) to compute the denominator (e.g., Σⱼ₌₁^{K} e^{z}^{ⱼ}), and another pass that divides each numerator value by the denominator, the stream is interrupted since the incoming values have to be buffered until the denominator is computed. For very large inputs (e.g., each row of Q and column of K can have millions of entries), the latency incurred while buffering the incoming values for the conventional softmax computation block 290 can be prohibitive. Further adding to the latency, the amount of data to be buffered can exceed the capacity of on-chip memory, requiring use of transfers (e.g., direct memory access (DMA) writes/reads) to/from a slower storage, which are typically performed as block-wise data transfers and do not support random accesses, thus incurring extra delay and power consumption.

As compared to the example 280, the softmax with norm folding mechanism 142 of the example 200 enables data flow in the attention computation to remain “streamable”—that is, no buffering or execution breakpoint is needed even for large sizes of Q and K—and enables depth-first computation.

To illustrate, in the example 200, each of the values z₁, z₂, z₃, . . . of the softmax input stream 224 is processed at the exponentiation operation 230 to generate corresponding softmax numerator values e^{z}^{ᵢ}, and the resulting stream of softmax numerator values 232 are input as a row of elements into a second matrix multiplication block. Due to the norm folding in the example 200, the “norm” operation—i.e., the division by the accumulated sum α—is not performed directly to the numerator values as in the conventional softmax processing of the example 280. Instead, the norm operation is “folded” into another operation—that is, the norm is applied to the numerator values indirectly, during the second matrix multiplication operation 240, after being multiplied to elements of V 206. As a result, no buffering or execution breakpoint interrupts the streamability of the attention computation.

FIG. 3 depicts an example 300 of components and operations that may be implemented in the device 102 of FIG. 1, according to some examples of the present disclosure. In particular, the example 300 illustrates components and operations that may be implemented in the streamable attention mechanism 144 in accordance with another example of norm folding.

In the example 300, the softmax input stream 224 is generated in a substantially similar manner as described for the example 200 and provided to the exponentiation operation 230. The stream of softmax numerator values 232 is input, in a first processing path, as a first input to the second matrix multiplication operation 240. Also in the first processing path, the third data (V) 206 is input to the second matrix multiplication operation 240, which operates to generate an output 342.

The streamable attention mechanism 144 is configured to perform a norm operation 350 to apply the accumulation sum 235 to an output 342 of the second matrix multiplication operation 240, such as by dividing the output 342 by the accumulation sum 235 (or equivalently, multiplying the output 342 by the inverse accumulation sum 237). For example, in a second processing path parallel to the first processing path, after all of the softmax numerator values 232 have been accumulated into the accumulation sum 235, the norm operation 350 includes applying the inverse operation 236 to generate the inverse accumulation sum 237. The inverse accumulation sum 237 is multiplied, at a multiplication operation 338, with the output 342 of the second matrix multiplication operation 240 to generate the attention output values 260.

Thus, in the example of FIG. 3, norm folding is illustrated in which the norm is applied to the output 342 of the second matrix multiplication operation 240. In general, the norm folding can be applied even later in the processing to ensure that the norm computation does not interrupt the streamability of the attention computation. According to some aspects, the attention mechanism can employ dynamic norm folding in which the location of the norm folding is dynamically selected, such as based on the sizes of Q and K.

Although the examples of FIG. 2 and FIG. 3 are illustrated and described in terms of operations performed by functional blocks, it should be understood that, in some embodiments, each of the operations or functional blocks generally corresponds to functions performed by one or more respective layers of a neural network.

FIG. 4 depicts an example 400 of the ML model 140 as a low-footprint model having an OF or DFS architecture that can be implemented in the system 100 of FIG. 1, in accordance with some examples of the present disclosure.

As shown in FIG. 4, the ML model 140 includes a convolutional neural network (CNN) 402A to perform feature extraction for the first image 124 to generate features 404A (e.g., a feature map) and a CNN 402B to perform feature extraction for the second image 126 to generate features 404B (e.g., a feature map).

A feature enhancement transformer 410 is configured to process the features 404A and 404B to generate enhanced features 412A and 412B, respectively. For example, the feature enhancement transformer 410 may be configured to perform self-attention processing, cross-attention processing, or a combination thereof, on the features 404A and 404B.

Feature matching is performed on the enhanced features 412A and 412B at a feature matching block 420 to generate an output 422. In an example, the feature matching block 420 can include or correspond to a softmax matching layer. The output 422 includes flow or disparity information based on whether the ML model 140 is configured to perform OF or DFS processing.

Propagation is performed on the output 422 and the enhanced features 412A at a propagation block 430, such as a self-attention layer. The propagation improves occluded and out-of-boundary pixels to generate an output 432 of the ML model 140. The output 432 includes flow or disparity information based on whether the ML model 140 is configured to perform OF or DFS processing.

According to an aspect, the feature enhancement transformer 410 includes a streamable attention mechanism 144A, the feature matching block 420 includes a streamable attention mechanism 144B, and the propagation block 430 includes a streamable attention mechanism 144C. Each of the streamable attention mechanisms 144A-C enables its respective processing block 410, 420, or 430 to perform attention processing without the quadratic memory requirement of conventional attention mechanisms that include conventional multi-pass softmax operations, and can help remove execution pipelining and memory bottlenecks associated with operating transformer models on mobile devices.

As illustrated, the ML model 140 has an overall architecture resembling a GMFlow model in which conventional attention mechanisms have been replaced by streamable attention mechanisms 144. Although GMFlow is a transformer-based model that does not explicitly compute a cost volume, the various softmax operations that are performed in GMFlow (e.g., in the feature enhancement transformer 410, in the feature matching block 420, and in the propagation block 430) can require a substantially similar amount of memory as a conventional cost volume approach.

Table 1 depicts an illustrative, non-limiting example of comparisons between the ML model 140, a CNN-based RAFT (Recurrent All-Pairs Field Transforms for Optical Flow) model, and a transformer-based GMFlow model. Data for the RAFT model is based on “RAFT: Recurrent All-Pairs Field Transforms for Optical Flow, ECCV 2020, and data for the GMFlow model is based on “GMFlow: Unifying Flow, Stereo, and Depth Estimation,” TPAMI IEEE 2023.

TABLE 1

| Optical | | | | | | Cost Vol Eq. | |
|---|---|---|---|---|---|---|---|
| Flow | Dataset #1: Flying Things | | | Dataset #2: Sintel | | Size on NSP | |
| Model | EPE: clean | S0_10 | S0_40 | EPE: clean | EPE: final | (VGA input) | |
| RAFT | 4.25 | 0.53 | 1.31 | 1.41 | 2.69 | 30.6 | MB |
| GMFlow | 2.80 | 0.53 | 1.01 | 1.08 | 2.48 | 23.0 | MB |
| FIG. 4 | 2.83 | 0.48 | 0.99 | 1.11 | 2.57 | 1.2 | MB |

In the example depicted in Table 1, the cost volume equivalent memory size (e.g., amount of memory used for a cost volume data structure and/or associated with cost-volume related computations) on a neural signal processor (NSP) using VGA input for the RAFT model is 30.6 megabytes (MB), 23.0 MB for the GMFlow model, and 1.2 MB for the ML model 140 of FIG. 4. Thus, the ML model 140 has approximately a 95% reduction in the associated memory usage as compared to the GMFlow model, with substantially similar performance metrics such as endpoint error (EPE) while keeping the model math equivalent. As a result, the associated memory usage of the ML model 140 can remain within the local memory capacity of an NSP, such as an 8 MB vector tightly coupled memory (VTCM) that may be used in mobile devices.

Although the particular example of the ML model 140 depicted in FIG. 4 has an overall architecture resembling that of GMFlow, in other embodiments the techniques disclosed herein can be used in conjunction with a variety of different architectures. For example, in other embodiments, feature extraction processing can omit the CNNs 402, the feature enhancement transformer 410, or both (e.g., another type of feature extractor can instead be used), the propagation block 430 can be omitted and/or replaced with another mechanism to improves occluded and out-of-boundary pixels, or a combination thereof.

FIG. 5 is a block diagram illustrating an implementation 500 of the device 102 as an integrated circuit 502 for performing input data processing using a low-footprint model. The integrated circuit 502 includes the one or more processors 116, which include the ML model 140 (e.g., including the softmax with norm folding mechanism 142 in the streamable attention mechanism 144). For example, the ML model 140 may include one or more of the components of the example 200 FIG. 2, the example 300 of FIG. 3, the example 400 of FIG. 4, or any combination thereof. The integrated circuit 502 also includes a signal input 504, such as a bus interface, to enable input data 505, such as the image data 105 or the input data 122, to be received. The integrated circuit 502 includes a signal output 506, such as a bus interface, to enable outputting of output data 507, such as the output data 152, the output image data 107, or the 3D representation 160. Optionally, the integrated circuit 502 also includes the memory 110, the image sensor 104, the input data source 120, the modem 118, a display engine, etc. The integrated circuit 502 enables implementation of input data processing (e.g., optical flow or depth from stereo processing) using a low-footprint model as a component in a system that performs image processing, such as depicted in FIG. 1.

FIG. 6 depicts an implementation 600 in which the device 102 includes a mobile device 602, such as a phone or tablet, as illustrative, non-limiting examples. The mobile device 602 includes a display screen 604 and a camera 612 (e.g., the image sensor 104). The ML model 140 is integrated in the mobile device 602, such as in the integrated circuit 502, which is illustrated using dashed lines to indicate internal components that are not generally visible to a user of the mobile device 602. In a particular example, the ML model 140 operates to perform input data processing (e.g., optical flow or depth from stereo processing). For example, the mobile device 602 may generate the image data 105 from the camera 612, process the image data 105 using the ML model 140, and display the resulting output image data 107 at the display screen 604 and/or transmit the resulting output image data 107, the output data 152, and/or the 3D representation 160 to another device, such as the remote device 198.

FIG. 7 depicts an implementation 700 in which the device 102 includes a portable electronic device that corresponds to a camera device 702. The camera device 702 includes an image sensor 712, such as the image sensor 104. The ML model 140 is integrated in the camera device 702, such as in the integrated circuit 502. In a particular example, the ML model 140 operates to perform input data processing (e.g., optical flow or depth from stereo processing). For example, the camera device 702 may generate the image data 105 from the image sensor 712, process the image data 105 using the ML model 140, and display the resulting output image data 107 at a display screen of the camera device 702, store the resulting output image data 107, the output data 152, and/or the 3D representation 160 at a memory of the camera device 702, and/or transmit the resulting output image data 107, the output data 152, and/or the 3D representation 160 to another device, such as the remote device 198.

FIG. 8 depicts an implementation 800 of a wearable electronic device 802, illustrated as a “smart watch.” In a particular aspect, the wearable electronic device 802 includes the device 102. The wearable electronic device 802 includes a display screen 804 and a camera 812 (e.g., the image sensor 104). The ML model 140 is integrated in the wearable electronic device 802, such as in the integrated circuit 502. In a particular example, the wearable electronic device 802 includes a haptic device that provides a haptic notification (e.g., vibrates) associated with display of image or video data that is based on image or video data that been captured by the camera 812 and processed by the ML model 140, such as the output image data 107, which may be displayed via the display screen 804. For example, the haptic notification can cause a user to look at the wearable electronic device 802 to watch video playback.

FIG. 9 depicts an implementation 900 in which the device 102 includes a portable electronic device that corresponds to an extended reality device, such as augmented reality or mixed reality glasses 902. The glasses 902 include a holographic projection unit 904 configured to project visual data onto a surface of a lens 906 or to reflect the visual data off of a surface of the lens 906 and onto the wearer's retina. The glasses 902 include a camera 912, such as the image sensor 104. The ML model 140 is integrated in the glasses 902, such as in the integrated circuit 502. In a particular example, the ML model 140 operates to perform input data processing (e.g., optical flow or depth from stereo processing). For example, the image data 105 may be received from the camera 912, processed using the ML model 140, and the resulting output image data 107 (e.g., an output image based on an output of the ML model 140) may be displayed via a projection onto the surface of the lens 906 to enable display of images and/or video associated with augmented reality, mixed reality, or virtual reality scenes to the user while the glasses 902 are worn.

FIG. 10 depicts an implementation 1000 in which the device 102 includes a portable electronic device that corresponds to a virtual reality, augmented reality, or mixed reality headset 1002. The headset 1002 includes a camera 1012, such as the image sensor 104, and a visual display device 1004. The ML model 140 is integrated in the headset 1002, such as in the integrated circuit 502. In a particular example, the ML model 140 operates to perform input data processing (e.g., optical flow or depth from stereo processing). For example, the image data 105 may be received from the camera 1012, processed using the ML model 140, and the resulting output image data 107 (e.g., an output image based on an output of the ML model 140) may be displayed at the visual display device 1004 to enable display of images and/or video associated with augmented reality, mixed reality, or virtual reality scenes to the user while the headset 1002 is worn.

FIG. 11 is an implementation 1100 of a wireless speaker and voice activated device 1102. In a particular aspect, the wireless speaker and voice activated device 1102 includes the device 102. The wireless speaker and voice activated device 1102 can have wireless network connectivity and is configured to execute an assistant operation. The one or more processors 116 are included in the wireless speaker and voice activated device 1102 and include the ML model 140.

The wireless speaker and voice activated device 1102 includes a camera 1112, such as the image sensor 104, and a display device 1120. In a particular example, the ML model 140 operates to perform input data processing (e.g., optical flow or depth from stereo processing). For example, the image data 105 may be received from the camera 1112 and processed using the ML model 140, and the resulting output image data 107 (e.g., an output image based on an output of the ML model 140) may be displayed at the display device 1120 and/or transmitted to a remote device for playback at the remote device.

In a particular aspect, the wireless speaker and voice activated device 1102 includes one or more microphones 1110 and one or more speakers 1104. During operation, in response to receiving a verbal command via one or more microphones 1110, the wireless speaker and voice activated device 1102 can execute assistant operations, such as via execution of a voice activation system (e.g., an integrated assistant application). The assistant operations can include adjusting a temperature, activating the camera 1112 to capture video or image content and displaying output image or video data based on the captured video content (e.g., the output image data 107) at the display device 1120, etc. For example, the assistant operations are performed responsive to receiving a command after a keyword or key phrase (e.g., “hello assistant”).

FIG. 12 depicts an implementation 1200 in which the device 102 corresponds to or is integrated within a vehicle 1202, illustrated as a manned or unmanned aerial device (e.g., a package delivery drone). The ML model 140 is integrated in the vehicle 1202, such as in the integrated circuit 502. The vehicle 1202 may also include a display device 1204 configured to display an output based on processing input data at the ML model 140, such as the output image data 107.

In some implementations, the vehicle 1202 is manned (e.g., carries a pilot, one or more passengers, or both), the display device 1204 is internal to a cabin of the vehicle 1202, and the input data processing (e.g., optical flow or depth from stereo processing) is performed using image and/or video capture via one or more cameras 1212 may be used to generate navigational information, such as based on depth or flow information and/or based on a 3D representation (e.g., the 3D representation 160) corresponding to one or more objects or a scene in the proximity of the vehicle 1202, such as for playback to a pilot or a passenger of the vehicle 1202 and/or for semi-autonomous or autonomous operation of the vehicle 1202. In another implementation, the vehicle 1202 is unmanned, the input data processing (e.g., optical flow or depth from stereo processing) is performed using image and/or video capture via one or more cameras 1212 to generate navigational information corresponding to one or more objects or a scene in the proximity of the vehicle 1202, which may be displayed to a remote operator of the vehicle 1202 and/or used for semi-autonomous or autonomous operation of the vehicle 1202.

In some embodiments, the display device 1204 and the camera 1212 are mounted to an external surface of the vehicle 1202, and the input data processing at the ML model 140 is performed during video playback to one or more viewers external to the vehicle 1202. For example, the vehicle 1202 may move (e.g., circle an outdoor audience during a concert) while playing out video or images based on video or image data captured via the camera 1212.

FIG. 13 depicts an implementation 1300 in which the device 102 corresponds to, or is integrated within, a vehicle 1302, illustrated as a car. The ML model 140 is integrated in the vehicle 1302, such as in the integrated circuit 502. In a particular example, the ML model 140 operates to perform input data processing based on image data received from one or more cameras 1312. The input data processing (e.g., optical flow or depth from stereo processing) may be used to generate navigational information, such as based on depth or flow information and/or based on a 3D representation (e.g., the 3D representation 160) corresponding to one or more objects or a scene in the proximity of the vehicle 1302, such as for playback to an operator of the vehicle 1302 via a display screen 1320 or a speaker 1310, and/or for semi-autonomous or autonomous operation of the vehicle 1302.

For example, in a particular embodiment, the vehicle 1302 may generate the image data 105 from the one or more cameras 1312, process the image data 105 at the ML model 140, and display the resulting output image data 107 at the display screen 1320 of the vehicle 1302, store the resulting output image data 107, the output data 152, and/or the 3D representation 160 at a memory of the vehicle 1302, and/or transmit the resulting output image data 107, the output data 152, and/or the 3D representation 160 to another device, such as the remote device 198. In a particular embodiment, one or more of the cameras 1312 can be mounted to capture an interior scene including one or more other passengers of the vehicle 1302, such as to monitor children in a rear seat of the vehicle 1302. Additionally, or alternatively, one or more of the cameras 1312 can correspond to forward-facing camera and/or rear-facing cameras that capture fields of view external to the vehicle 1302 in conjunction with autonomous or driver-assisted operation of the vehicle 1302.

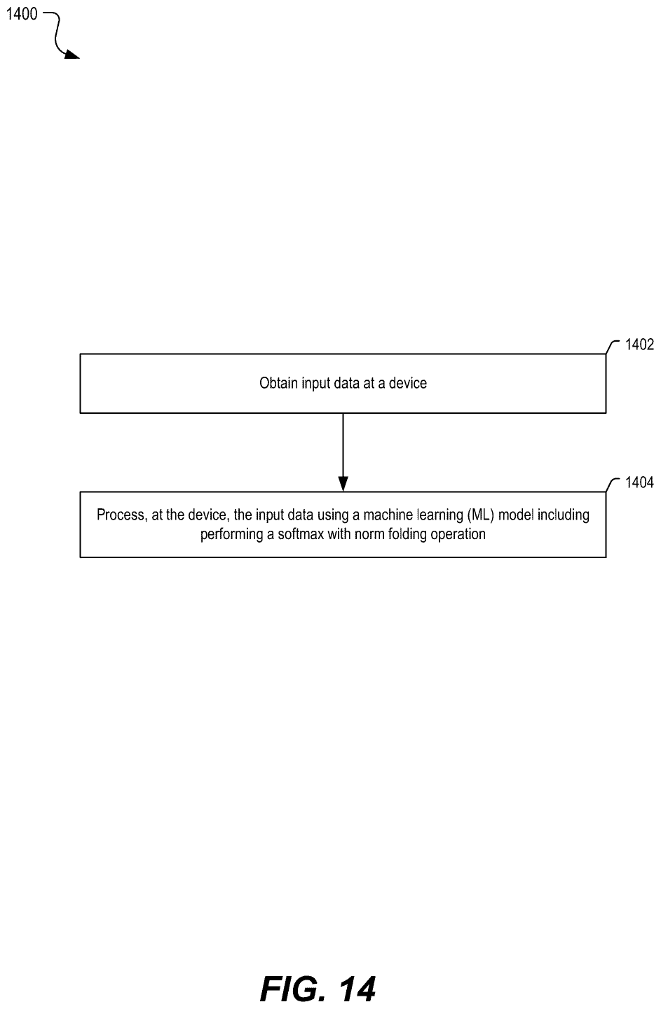

FIG. 14 illustrates an example of a method 1400 of input data processing. One or more operations of the method 1400 may be performed by at least one of the device 102, the one or more processors 116, or the system 100 of FIG. 1, as an illustrative, non-limiting example.

The method 1400 includes, at block 1402, obtaining input data at a device. For example, the input data 122 may be obtained from the input data source 120, via the image data 105 from the image sensor 104, or from the remote device 198.

The method 1400 includes, at block 1404, processing, at the device, the input data using a machine learning (ML) model including performing a softmax with norm folding operation. For example, the device 102 processes the input data 122 at the ML model 140 that includes the softmax with norm folding mechanism 142. In some embodiments, the softmax with norm folding operation is included in a streamable attention operation of the ML model, such as performed by the streamable attention mechanism 144 in accordance with the example 200 of FIG. 2 or the example 300 of FIG. 3. According to an aspect. The input data includes a first image and a second image, such as the first image 124 and the second image 126, and the ML model corresponds to a depth from stereo or optical flow architecture, such as described with reference to the example 400 of FIG. 4.

In some embodiments, the streamable attention operation includes generating a softmax input stream based on a first matrix multiplication operation of a particular row of first data and a corresponding row of second data. For example, the softmax input stream 224 is generated based on the first matrix multiplication operation 210 of the example 200 or the example 300. The streamable attention operation may also include applying an exponentiation operation of the softmax with norm folding operation to the softmax input stream to generate a stream of softmax numerator values, such as the steam of softmax numerator values 232 generated by applying the exponentiation operation 230 to the softmax input stream 224 of the example 200 or the example 300. The streamable attention operation may include providing the stream of softmax numerator values as a first input to a second matrix multiplication operation, such as the second matrix multiplication operation 240 of the example 200 or the example 300, and generating an accumulation sum of the softmax numerator values. For example, the sum operation 234 of the example 200 or the example 300 generates the accumulation sum 235, which is inverted and applied at a later stage of the attention computation path via a norm folding operation.

By processing the input data using an ML model including performing the softmax with norm folding operation, the device can avoid the conventional buffering of the stream of softmax numerator values (e.g., buffering of the softmax numerator values until a normalization value has been computed and applied to the buffered softmax numerator values), reducing latency associated with the softmax operation and also avoiding additional latency and power consumption associated with performing data transfers to/from another storage of the device 102 that may otherwise arise in conjunction with the buffering. In addition, avoiding buffering of the stream of softmax numerator values enables use of just-in-time computations, depth-first computations, or both, associated with processing of the softmax numerator values, reducing the total amount of memory used to process the input data at the ML model.

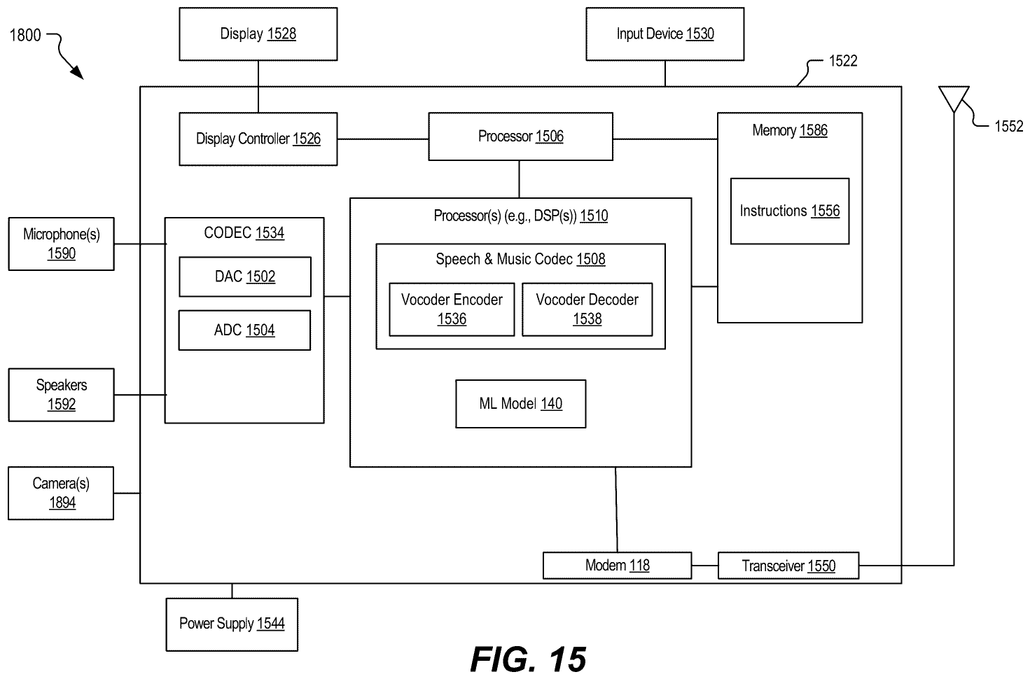

The method 1400 of FIG. 15 may be implemented by a field-programmable gate array (FPGA) device, an application-specific integrated circuit (ASIC), a processing unit such as a central processing unit (CPU), a digital signal processor (DSP), a controller, another hardware device, firmware device, or any combination thereof. As an example, the method 1400 of FIG. 14 may be performed by a processor that executes instructions, such as described with reference to FIG. 15.

Referring to FIG. 15, a block diagram of a particular illustrative implementation of a device is depicted and generally designated 1500. In various implementations, the device 1500 may have more or fewer components than illustrated in FIG. 15. In an illustrative implementation, the device 1500 may correspond to the device 102 of FIG. 1. In an illustrative implementation, the device 1500 may perform one or more operations described with reference to FIGS. 1-14.

In a particular implementation, the device 1500 includes a processor 1506 (e.g., a CPU). The device 1500 may include one or more additional processors 1510 (e.g., one or more DSPs). In a particular implementation, the one or more processors 116 of FIG. 1 correspond to the processor 1506, the processors 1510, or a combination thereof. For example, the processors 1510 may include the ML model 140. For example, the ML model 140 may include one or more of the components of the example 200 of FIG. 2, the example 300 of FIG. 3, the example 400 of FIG. 4, or a combination thereof. The processors 1510 may also include a speech and music coder-decoder (CODEC) 1508. The speech and music CODEC 1508 may include a voice coder (“vocoder”) encoder 1536, a vocoder decoder 1538, or a combination thereof.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, CPUs, digital signal processors DSPs, neural processing units (NPUs), graphics processing units (GPUs), FPGAs, microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

The device 1500 may include a memory 1586 and a CODEC 1534. The memory 1586 may include instructions 1556 that are executable by the one or more additional processors 1510 (or the processor 1506) to implement the functionality described with reference to the processor 116. In a particular example, the memory 1586 corresponds to the memory 110 and the instructions 1556 correspond to the instructions 112 of FIG. 1. The device 1500 may include the modem 118 coupled, via a transceiver 1550, to an antenna 1552. The device 1500 may also include one or more cameras 1594, one or more of which may correspond to the image sensor 104.

The device 1500 may include a display 1528, such as the display device 106, coupled to a display controller 1526. One or more speakers 1592, one or more microphones 1590, or a combination thereof, may be coupled to the CODEC 1534. The CODEC 1534 may include a digital-to-analog converter (DAC) 1502 and an analog-to-digital converter (ADC) 1504. In a particular implementation, the CODEC 1534 may receive analog signals from the microphones 1590, convert the analog signals to digital signals using the analog-to-digital converter 1504, and send the digital signals to the speech and music codec 1508. In a particular implementation, the speech and music codec 1508 may provide digital signals to the CODEC 1534. The CODEC 1534 may convert the digital signals to analog signals using the digital-to-analog converter 1502 and may provide the analog signals to the speakers 1592.

In a particular implementation, the device 1500 may be included in a system-in-package or system-on-chip device 1522. In a particular implementation, the memory 1586, the processor 1506, the processors 1510, the display controller 1526, the CODEC 1534, and the modem 118 are included in a system-in-package or system-on-chip device 1522. In a particular implementation, an input device 1530 (e.g., a keyboard, a touchscreen, or a pointing device) and a power supply 1544 are coupled to the system-in-package or system-on-chip device 1522. Moreover, in a particular implementation, as illustrated in FIG. 15, the cameras 1594, the display 1528, the input device 1530, the speakers 1592, the microphones 1590, the antenna 1552, and the power supply 1544 are external to the system-in-package or system-on-chip device 1522. In a particular implementation, each of the cameras 1594, the display 1528, the input device 1530, the speakers 1592, the microphones 1590, the antenna 1552, and the power supply 1544 may be coupled to a component of the system-in-package or system-on-chip device 1522, such as an interface or a controller.

The device 1500 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a vehicle, a computing device, a communication device, an internet-of-things (IoT) device, a virtual reality (VR) device, a base station, a mobile device, or any combination thereof.

In conjunction with the described techniques, an apparatus includes means for obtaining input data. In an example, the means for obtaining input data can include input data source 120, the image sensor 104, the modem 118, the one or more processors 116, the device 102, the system 100, one or more other circuits or devices to obtain input data, or a combination thereof.

The apparatus also includes means for processing the input data using a machine learning model that incorporates means for performing a softmax with norm folding operation. In an example, the means for processing the input data using a machine learning model that incorporates means for performing a softmax with norm folding operation can include the one or more processors 116, the ML model 140 executed by the one or more processors 116, the device 102, the system 100, one or more other circuits or devices to process the input data using a machine learning model that incorporates means for performing a softmax with norm folding operation, or a combination thereof. In an example, means for performing a softmax with norm folding operation can include the one or more processors 116, the softmax with norm folding mechanism 142, the streamable attention mechanism 144, the device 102, the system 100, one or more other circuits or devices to perform a softmax with norm folding operation, or a combination thereof.

In some implementations, a non-transitory computer-readable medium (e.g., a computer-readable storage device, such as the memory 110) includes instructions (e.g., the instructions 112) that, when executed by one or more processors (e.g., the one or more processors 116), cause the one or more processors to perform operations corresponding to at least a portion of any of the techniques described with reference to FIGS. 1-13, the method of FIG. 14, or any combination thereof. In an example, the instructions, when executed by the one or more processors, cause the one or more processors to obtain input data (e.g., the input data 122). The instructions, when executed by the one or more processors, also cause the one or more processors to process the input data using a machine learning model (e.g., the ML model 140) that incorporates a softmax with norm folding mechanism (e.g., the softmax with norm folding mechanism 142).

Particular aspects of the disclosure are described below in the following sets of interrelated Examples:

According to Example 1, a device includes a memory configured to store input data; and one or more processors configured to process the input data using a machine learning (ML) model that incorporates a softmax with norm folding mechanism.

Example 2 includes the device of Example 1, wherein the input data includes a first image and a second image, and wherein the ML model corresponds to a depth from stereo or optical flow architecture.

Example 3 includes the device of Example 1 or Example 2, wherein the softmax with norm folding mechanism is included in a streamable attention mechanism.

Example 4 includes the device of Example 3, wherein the streamable attention mechanism is configured to generate a softmax input stream based on a first matrix multiplication operation of a particular row of first data and a corresponding row of second data; apply an exponentiation operation of the softmax with norm folding mechanism to the softmax input stream to generate a stream of softmax numerator values; input the stream of softmax numerator values as a first input to a second matrix multiplication operation; and generate an accumulation sum of the softmax numerator values.

Example 5 includes the device of Example 4, wherein the streamable attention mechanism is configured to perform a norm operation to apply the accumulation sum to third data to generate a second input to the second matrix multiplication operation.

Example 6 includes the device of Example 4, wherein the streamable attention mechanism is configured to perform a norm operation to apply the accumulation sum to an output of the second matrix multiplication operation.

Example 7 includes the device of any of Examples 4 to 6, wherein: the first data corresponds to features associated with a first image; the second data corresponds to features associated with a second image; and a second input to the second matrix multiplication operation corresponds to a displacement matrix of coordinates.

Example 8 includes the device of any of Examples 1 to 7, wherein the ML model generates probabilistic geometry measures without generating a cost volume data structure.

Example 9 includes the device of any of Examples 1 to 8, wherein the ML model is configured to perform regression for depth from stereo or optical flow geometric coordinates using just-in-time computations.

Example 10 includes the device of any of Examples 1 to 9 and further includes an image sensor configured to generate image data corresponding to the input data.

Example 11 includes the device of any of Examples 1 to 10 and further includes a modem coupled to the one or more processors, the modem configured to receive image data corresponding to the input data from a second device.

Example 12 includes the device of any of Examples 1 to 11, wherein the one or more processors are integrated in a headset device that includes a display, and wherein the headset device is configured, when worn by a user, to display an output image based on an output of the ML model.

Example 13 includes the device of any of Examples 1 to 11, wherein the one or more processors are integrated in at least one of a mobile phone, a tablet computer device, a wearable electronic device, or a camera device.

Example 14 includes the device of any of Examples 1 to 11, wherein the one or more processors are integrated in a vehicle, the vehicle further including one or more cameras configured to capture image data corresponding to the input data.

Example 15 includes the device of any of Examples 1 to 14, wherein the one or more processors are included in an integrated circuit.

Example 16 includes the device of any of Examples 1 to 15, wherein the ML model includes a language model, a vision model, or a multi-modal model.

According to Example 17, a method includes obtaining input data at a device; and processing, at the device, the input data using a machine learning (ML) model including performing a softmax with norm folding operation.

Example 18 includes the method of Example 17, wherein the input data includes a first image and a second image, and wherein the ML model corresponds to a depth from stereo or optical flow architecture.

Example 19 includes the method of Example 17 or Example 18, wherein the softmax with norm folding operation is included in a streamable attention operation of the ML model.

Example 20 includes the method of Example 19, wherein the streamable attention operation includes: generating a softmax input stream based on a first matrix multiplication operation of a particular row of first data and a corresponding row of second data; applying an exponentiation operation of the softmax with norm folding operation to the softmax input stream to generate a stream of softmax numerator values; providing the stream of softmax numerator values as a first input to a second matrix multiplication operation; and generating an accumulation sum of the softmax numerator values.

Example 21 includes the method of Example 20, wherein the streamable attention operation includes performing a norm operation to apply the accumulation sum to third data to generate a second input to the second matrix multiplication operation.

Example 22 includes the method of Example 20, wherein the streamable attention operation includes performing a norm operation to apply the accumulation sum to an output of the second matrix multiplication operation.

Example 23 includes the method of any of Examples 20 to 22, wherein: the first data corresponds to features associated with a first image; the second data corresponds to features associated with a second image; and a second input to the second matrix multiplication operation corresponds to a displacement matrix of coordinates.

Example 24 includes the method of any of Examples 17 to 23, wherein the ML model generates probabilistic geometry measures without generating a cost volume data structure.

Example 25 includes the method of any of Examples 17 to 24, wherein the ML model performs regression for depth from stereo or optical flow geometric coordinates using just-in-time computations.

Example 26 includes the method of any of Examples 17 to 25 and further includes receiving image data corresponding to the input data.

Example 27 includes the method of any of Examples 17 to 26 and further includes receiving image data corresponding to the input data from a second device.

Example 28 includes the method of any of Examples 17 to 27 and further includes displaying an output image based on an output of the ML model.

Example 29 includes the method of any of Examples 17 to 28, wherein the ML model includes a language model, a vision model, or a multi-modal model.

According to Example 30, a non-transitory computer-readable medium storing instructions that, when executed by one or more processors, cause the one or more processors to obtain input data; and process the input data using a machine learning (ML) model that incorporates a softmax with norm folding mechanism.

Example 31 includes the non-transitory computer-readable medium of Example 30, wherein the softmax with norm folding mechanism is included in a streamable attention mechanism.

Example 32 includes the non-transitory computer-readable medium of Example 30 or Example 31, wherein the instructions, when executed by the one or more processors, cause the one or more processors to generate, at the streamable attention mechanism, a softmax input stream based on a first matrix multiplication operation of a particular row of first data and a corresponding row of second data; apply, at the streamable attention mechanism, an exponentiation operation of the softmax with norm folding mechanism to the softmax input stream to generate a stream of softmax numerator values; input, at the streamable attention mechanism, the stream of softmax numerator values as a first input to a second matrix multiplication operation; and generate, at the streamable attention mechanism, an accumulation sum of the softmax numerator values.

Example 33 includes the non-transitory computer-readable medium of Example 32, wherein the instructions, when executed by the one or more processors, cause the one or more processors to perform, at the streamable attention mechanism, a norm operation to apply the accumulation sum to third data to generate a second input to the second matrix multiplication operation.

Example 34 includes the non-transitory computer-readable medium of Example 32, wherein the instructions, when executed by the one or more processors, cause the one or more processors to perform, at the streamable attention mechanism, a norm operation to apply the accumulation sum to an output of the second matrix multiplication operation.

Example 35 includes the non-transitory computer-readable medium of any of Examples 32 to 34, wherein: the first data corresponds to features associated with a first image; the second data corresponds to features associated with a second image; and a second input to the second matrix multiplication operation corresponds to a displacement matrix of coordinates.

Example 36 includes the non-transitory computer-readable medium of any of Examples 30 to 35, wherein the instructions, when executed by the one or more processors, cause the one or more processors to generate, at the ML model, probabilistic geometry measures without generating a cost volume data structure.

Example 37 includes the non-transitory computer-readable medium of any of Examples 30 to 36, wherein the instructions, when executed by the one or more processors, cause the one or more processors to perform regression, at the ML model, for depth from stereo or optical flow geometric coordinates using just-in-time computations.

Example 38 includes the non-transitory computer-readable medium of any of Examples 30 to 37, wherein the ML model includes a language model, a vision model, or a multi-modal model.

According to Example 39, an apparatus includes means for obtaining input data; and means for processing the input data using a machine learning (ML) model that incorporates means for performing a softmax with norm folding operation.

Example 40 includes the apparatus of Example 39, wherein the input data includes a first image and a second image, and wherein the ML model corresponds to a depth from stereo or optical flow architecture.

Example 41 includes the apparatus of Example 39 or Example 40, wherein the means for performing a softmax with norm folding operation is included in a means for performing a streamable attention operation.

Example 42 includes the apparatus of Example 41, wherein the means for performing a streamable attention operation includes: means for generating a softmax input stream based on a first matrix multiplication operation of a particular row of first data and a corresponding row of second data; means for applying an exponentiation operation of the softmax with norm folding operation to the softmax input stream to generate a stream of softmax numerator values; means for providing the stream of softmax numerator values as a first input to a second matrix multiplication operation; and means for generating an accumulation sum of the softmax numerator values.

Example 43 includes the apparatus of Example 42, wherein the means for performing a streamable attention operation includes means for performing a norm operation to apply the accumulation sum to third data to generate a second input to the second matrix multiplication operation.

Example 44 includes the apparatus of Example 42, wherein the means for performing a streamable attention operation includes means for performing a norm operation to apply the accumulation sum to an output of the second matrix multiplication operation.

Example 45 includes the apparatus of any of Examples 42 to 44, wherein: the first data corresponds to features associated with a first image; the second data corresponds to features associated with a second image; and a second input to the second matrix multiplication operation corresponds to a displacement matrix of coordinates.

Example 46 includes the apparatus of any of Examples 39 to 45, wherein the means for processing the input data using an ML model generates probabilistic geometry measures without generating a cost volume data structure.

Example 47 includes the apparatus of any of Examples 39 to 46, wherein the means for processing the input data using an ML model performs regression for depth from stereo or optical flow geometric coordinates using just-in-time computations.

Example 48 includes the apparatus of any of Examples 39 to 47 and further includes means for receiving image data corresponding to the input data.

Example 49 includes the apparatus of any of Examples 39 to 48 and further includes means for receiving image data corresponding to the input data from a second device.

Example 50 includes the apparatus of any of Examples 39 to 49 and further includes means for displaying an output image based on an output of the ML model.

Example 51 includes the apparatus of any of Examples 39 to 50, wherein the ML model includes a language model, a vision model, or a multi-modal model.

Those of skill would further appreciate that the various illustrative logical blocks, configurations, circuits, and algorithm steps described in connection with the implementations disclosed herein may be implemented as electronic hardware, computer software executed by a processing device such as a hardware processor, or combinations of both. Various illustrative components, blocks, configurations, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary memory device is coupled to the processor such that the processor can read information from, and write information to, the memory device. In the alternative, the memory device may be integral to the processor. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A device comprising:
a memory configured to store input data; and
one or more processors configured to process the input data using a machine learning (ML) model that incorporates a softmax with norm folding mechanism.

2. The device of claim 1, wherein the input data includes a first image and a second image, and wherein the ML model corresponds to a depth from stereo or optical flow architecture.

3. The device of claim 1, wherein the ML model includes a language model, a vision model, or a multi-modal model.

4. The device of claim 1, wherein the softmax with norm folding mechanism is included in a streamable attention mechanism.

5. The device of claim 4, wherein the streamable attention mechanism is configured to:
generate a softmax input stream based on a first matrix multiplication operation of a particular row of first data and a corresponding row of second data;
apply an exponentiation operation of the softmax with norm folding mechanism to the softmax input stream to generate a stream of softmax numerator values;
input the stream of softmax numerator values as a first input to a second matrix multiplication operation; and
generate an accumulation sum of the softmax numerator values.

6. The device of claim 5, wherein the streamable attention mechanism is configured to perform a norm operation to apply the accumulation sum to third data to generate a second input to the second matrix multiplication operation.

7. The device of claim 5, wherein the streamable attention mechanism is configured to perform a norm operation to apply the accumulation sum to an output of the second matrix multiplication operation.

8. The device of claim 5, wherein:
the first data corresponds to features associated with a first image;
the second data corresponds to features associated with a second image; and
a second input to the second matrix multiplication operation corresponds to a displacement matrix of coordinates.

9. The device of claim 1, wherein the ML model generates probabilistic geometry measures without generating a cost volume data structure.

10. The device of claim 1, wherein the ML model is configured to perform regression for depth from stereo or optical flow geometric coordinates using just-in-time computations.

11. The device of claim 1, further comprising an image sensor configured to generate image data corresponding to the input data.

12. The device of claim 1, further comprising a modem coupled to the one or more processors, the modem configured to receive image data corresponding to the input data from a second device.

13. The device of claim 1, wherein the one or more processors are integrated in a headset device that includes a display, and wherein the headset device is configured, when worn by a user, to display an output image based on an output of the ML model.

14. The device of claim 1, wherein the one or more processors are integrated in at least one of a mobile phone, a tablet computer device, a wearable electronic device, or a camera device.

15. The device of claim 1, wherein the one or more processors are integrated in a vehicle, the vehicle further including one or more cameras configured to capture image data corresponding to the input data.

16. The device of claim 1, wherein the one or more processors are included in an integrated circuit.

17. A method comprising:
obtaining input data at a device; and
processing, at the device, the input data using a machine learning (ML) model including performing a softmax with norm folding operation.

18. The method of claim 17, wherein the softmax with norm folding operation is included in a streamable attention operation of the ML model.

19. The method of claim 18, wherein the streamable attention operation includes:
generating a softmax input stream based on a first matrix multiplication operation of a particular row of first data and a corresponding row of second data;
applying an exponentiation operation of the softmax with norm folding operation to the softmax input stream to generate a stream of softmax numerator values;
providing the stream of softmax numerator values as a first input to a second matrix multiplication operation; and
generating an accumulation sum of the softmax numerator values.

20. A non-transitory computer-readable medium storing instructions that, when executed by one or more processors, cause the one or more processors to:
obtain input data; and
process the input data using a machine learning (ML) model that incorporates a softmax with norm folding mechanism.
